(19) United States
(12) Patent Application Publication
(10) Pub. No.: US 2019/0007159 A1
(43) Pub. Date: Jan. 3, 2019

(54) DOWNHOLE ADAPTIVE MULTIBAND COMMUNICATION SYSTEM

(71) Applicant: SCHLUMBERGER TECHNOLOGY CORPORATION, Sugar Land, TX (US)

(72) Inventors: Yann Dufour, Clamart (FR); Louis Dallet, Clamart (FR); Benoit Deville, Rosharon, TX (US); Michael John Ross Brown, Clamart (FR)

(21) Appl. No.: 16/026,775

(22) Filed: Jul. 3, 2018

(30) Foreign Application Priority Data
Jul. 3, 2017 (EP) 17290086.2

(51) Int. Cl. H04L 1/00; H04L 1/20; H04L 12/26; E21B 47/12

(52) U.S. Cl. CPC H04L 1/0001; E21B 47/12; H04L 43/0823; H04L 1/20

(57) ABSTRACT

An adaptive multiband access communication system and method for a network of downhole components located in a wellbore are disclosed. Low noise regions of a communication spectrum are identified and frequency channels within the low noise regions are assigned to the downhole components. Communications on the assigned channels are monitored for quality and adjustments are dynamically made to frequency channel assignments if the quality does not satisfy an acceptance criterion.

### BACKGROUND

Hydrocarbon fluids, including oil and natural gas, can be obtained from a subterranean geologic formation, referred to as a reservoir, by drilling a wellbore that penetrates the formation. Once a wellbore is drilled, various well completion components are installed to enable and control the production of fluids from the reservoir. Data representative of various downhole parameters, such as downhole pressure and temperature, are often monitored and communicated to the surface during operations before, during and after completion of the well, such as during drilling, perforating, fracturing and well testing operations. In addition, control information often is communicated from the surface to various downhole components to enable, control or modify the downhole operations.

Accurate and reliable communications between the surface and downhole components during operations can be difficult. For example, electrical noise generated by various equipment or tools, such as a surface power generator near the wellbore or an electrical submersible pump (ESP) in the completion string, can interfere with communications. Disruptions in communications can be costly as they can significantly increase the time to perform an operation or impede a timely response to an undesirable condition in the wellbore.

### SUMMARY

According to various embodiments, a method of multiband communications for communication nodes in a wellbore is disclosed. Frequency bands within a frequency spectrum for multiband communication are assigned to the communication nodes. The nodes transmit information associated with downhole equipment in accordance with the frequency band assignments. A receiver determines quality of the received information on each frequency band. If the quality does not satisfy an acceptance criterion, the frequency band assignment is adjusted, and the communication nodes then communicate information in accordance with the adjusted frequency band assignment.

According to various embodiments, a communication system for communicating with downhole components in a wellbore is disclosed. The communication system includes a transmission medium deployed in a wellbore that has a downlink and a multiband access uplink. The system also includes a plurality of downhole components coupled to the transmission medium, wherein the downhole components are assigned respective frequency channels on the multiband access uplink in which to transmit communication signals carrying data measured by the downhole components. A receiver assembly receives the communication signals from the downhole components. The system further includes a transmitter assembly that transmits frequency channel assignments to the downhole components on the downlink. The frequency channel assignments are determined dynamically by analyzing quality of the communication signals received in each frequency channel, determining whether the quality meets a quality criterion, and adapting assignment of frequency channels to the downhole components if the quality does not meet the quality criterion.

According to various embodiments, a method of communicating with communication nodes in a multiband medium access network is disclosed. The communication method includes assigning frequency bands within a frequency spectrum for multiband communication to the communication nodes. The communication nodes transmit information to a receiver in accordance with the frequency band assignments. The quality of the received information on each frequency band is determined, and a frequency band assignment is adjusted if the quality does not satisfy an acceptance criterion. The adjusted frequency band assignment is then sent to the corresponding communication node.

### BRIEF DESCRIPTION OF THE DRAWINGS

Certain embodiments are described with reference to the accompanying drawings, wherein like reference numerals denote like elements. It should be understood, however, that the accompanying drawings illustrate the various implementations described herein and are not meant to limit the scope of various technologies described herein. The drawings show and describe various embodiments.

FIG. 1 is a schematic illustration of an adaptive multiband communication system deployed in a wellbore, according to an embodiment.

FIG. 2 is a schematic illustration of a communication node, according to an embodiment.

FIG. 3 is a process flow for an adaptive multiband communication system, according to an embodiment.

FIG. 4 is a graph illustrating an exemplary signal waveform generated in an adaptive multiband communication system, according to an embodiment.

FIG. 5 is a graph illustrating the frequency spectrum of the signal waveform of FIG. 4.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

In the specification and appended claims: the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”, “upper” and “lower”, “upwardly” and downwardly”, “upstream” and “downstream”; “above” and “below”; and other like terms indicating relative positions above or below a given point or element are used in this description to more clearly describe some embodiments of the invention.

Communication systems for transmitting information, such as telemetry data and control information, between the surface and downhole components are faced with numerous challenges. As just one example, operations performed within downhole environments can introduce electrical noise which can affect the quality of communications and, thus, the ability to reliably send and receive information within a communications network. When the downhole environment is a hydrocarbon-producing well, electrical noise levels can increase substantially due to tools or other equipment that are operated during drilling, testing, completion or production. In general, provided that the Signal to Interference and Noise Ratio (“SINR”) or Signal to Noise Ratio (“SNR”) is sufficiently high, then information can be reliably received and communicated. Likewise, when the SNR is too low, signal quality can be degraded and difficulties encountered in reliably receiving information.

Downhole communication systems generally provide for communications between the surface and various downhole equipment (or tools) positioned at various locations in the wellbore. Examples of equipment include temperature sensors, pressure gauges, flow meters, fluid analyzers and actuator controllers, along with many other types of equipment that are known and used. Communications between surface equipment (on land or at sea) and the downhole tools can occur over a wired medium, such as a cable or other transmission medium that is run along, within or integrated into a downhole tubing, such as a drill string, test string, production tubing or the like.

In embodiments disclosed herein, one or more tools are associated with a communication node that is positioned along the tubing and connected to the transmission medium so that the nodes can communicate with a surface system. The communication node implements communications on the transmission medium by modulating data onto carrier signals, where each communication node is assigned a different frequency band within a relatively noise-free area of the available frequency spectrum. Because of the use of multiband medium access, multiple tools can communicate with the surface at the same time. As would be recognized by the person of skill in the art, a variety of suitable modulation schemes can be used for communications, including QPSK, OOK, PCM, QAM and FSK as examples, depending on the particular environment and operating conditions in which the communication system is deployed.

However, because the operating environment in a wellbore continuously changes, noise of different levels and different spectral components can be introduced at any time. The dynamic nature of the noise can make it difficult to ensure reliable communications between the communication nodes and the surface. For example, operation of an electrical submersible pump in the downhole environment may degrade over time, generating more noise and thus decreasing the SNR in a region of the communication spectrum that had previously had a relatively high SNR. Or, a new noise source may be introduced that generates noise in a region of the spectrum that previously had no noise or low noise levels. If these regions include one or more frequency bands assigned to a communication node(s), then the communication node(s) may no longer be able to communicate with the surface system or transmissions received from the node may have an unacceptably high error rate.

Accordingly, embodiments described herein provide a system and technique for dynamically adapting the communication network in order to provide for communications that have strong noise immunity. Embodiments dynamically adapt the communication network based on observed noise levels on the transmission medium and/or measurements of the quality of the signals received in a particular frequency channel. For example, frequency channel assignments can be adjusted to move assigned channels based on a scan of the communication spectrum that reveals regions of the spectrum with high noise. Assignments also can be adjusted based on low SNRs or unacceptably high data error rates on a particular channel. In some embodiments, the frequency channel adjustments also can be implemented by adjusting the bandwidth of a channel that is assigned to a node. For example, if a particular channel is exhibiting a high error rate, the bandwidth can be reduced to decrease the amount of data that is transmitted. In yet other embodiments, the frequency channel adjustments can entail increasing the strength of the signal emitted into the frequency channel or changing the technique used to modulate data onto the signal.

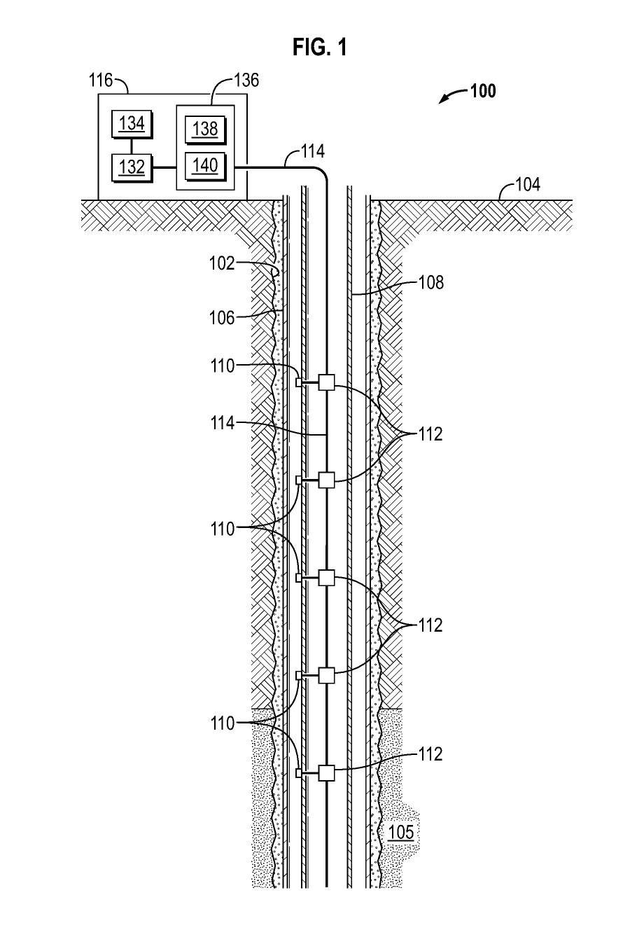

Turning now to FIG. 1, an adaptive communication system 100 that can be deployed in a downhole environment is schematically illustrated. In FIG. 1, a wellbore 102 has been drilled that extends from a surface 104 and through a hydrocarbon-bearing formation or other region of interest 105, and a casing 106 has been lowered into the wellbore 102. Although a cased vertical well structure is shown, it should be understood that embodiments of the subject matter of this application are not limited to this illustrative example. Uncased, open hole, gravel packed, deviated, horizontal, multi-lateral, deep sea or terrestrial surface injection and/or production wells (among others) can incorporate the communication network as will be described herein.

In the embodiment shown, a tubing 108, such as a test string or production tubing, extends from the surface to the region of interest 105 in the wellbore 102. Although not shown, a packer can be positioned on the tubing 108 and can be actuated to seal the wellbore 102 around the tubing 108 at a region of interest. Various downhole tools 110 can be connected to the tubing 108 above or below the packer, including, for example, additional packers, valves, chokes, firing heads, perforators, samplers, pressure gauges, temperature sensors, flow meters, fluid analyzers, etc. In the embodiment shown, each downhole tool 110 is associated with a communication node 112 that is connected to a transmission medium 114 (e.g., a cable). In this example, five nodes 112 are shown. However, it should be understood that more or only one node 112 can be implemented depending on the particular application in which the system is deployed and the available communication spectrum. Electrical signals are communicated between the nodes 112 and a surface system 116 via the transmission medium 114. The electrical signals can encompass control signals, commands, polls for data, and telemetry information, such as data regarding tool status, temperature data, pressure data, production data, diagnostic data or other information indicative of other parameters of interest in the downhole environment.

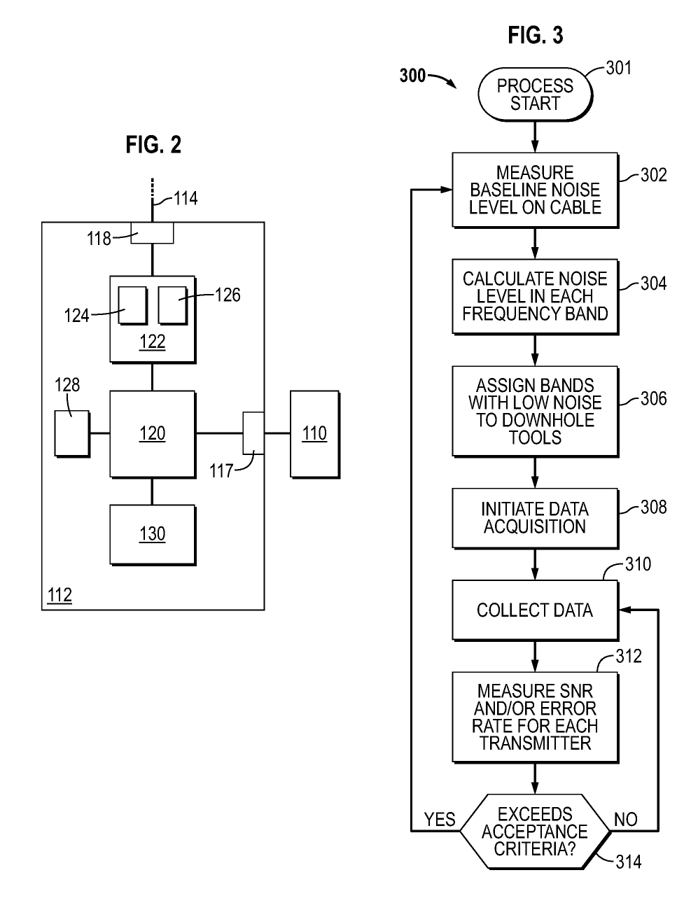

A schematic illustration of an exemplary communication node 112 is shown in FIG. 2. A communication node 112 can be associated with one or more tools 110 that either are integrated into the node or that interface with the node through a port. For example, the node 112 can include a sensor for obtaining measurements of pressure and/or temperature. Or, the node 112 can include one or more ports 116 for interfacing with the sensor or tool 110. The node 112 also includes one or more ports 118 for interfacing with the transmission medium 114.

As shown in FIG. 2, the node 112 also includes a processing system 120 in communication with the sensor 110. The processing system 120 is configured to process the sensor measurements in a known manner to convert the measurements into telemetry data that can be transmitted to the surface system 116 via the transmission medium 114. For example, the processing system 120 can include a microcontroller, microprocessor, programmable gate array, an analog-to-digital converter, signal filters, signal conditioners, signal amplifiers, an encoder and a modulator to modulate the data onto a carrier signal for transmission to the surface via the transmission medium. In embodiments, the processing system 120 can also include a demodulator, a decoder and other components arranged to process and/or analyze signals received from the transmission medium 114. In some embodiments, the processing system 120 can be configured to measure the SNR of the received signals and to determine an error rate.

The node 112 also includes a transceiver assembly 122 coupled to the processing system 120 and to the transmission medium 114. The transceiver assembly 122 includes a transmitter 124 and a receiver 126 for sending and receiving signals on the transmission medium 114.

The node 112 can also include a memory or storage system 128 to store data representative of the sensor measurements either in a cache or so that it can be retrieved and transmitted to the surface at a later time. Yet further, the memory or storage system 128 can store instructions of software for execution by the processing system 120 to perform the various modulation, demodulation, encoding, decoding, and analysis processes described herein.

The node 112 also can include a power source 130. The power source 130 can be implemented as a local energy source (e.g., a battery) or can be implemented as power supply circuitry that conditions power received from a power generator at the surface 104 (e.g., via communications medium 114) in a manner that is suitable to power the node 112 electronics.

Returning now to FIG. 1, the communication nodes 112 are configured to communicate with the surface system 116. The communication nodes 112 can be connected in a series configuration on the transmission medium 114 or in a parallel configuration. Regardless of the configuration, the communication system is a multiband medium access system where the nodes 112 use different frequency channels to transmit information to the surface system 116 at the same time. To that end, nodes 112 modulate data onto carrier signals transmitted on the transmission medium 114 so that the signals are additive at the surface system 116. For example, data can be transmitted to the surface using current sink circuitry. As would be recognized by the person skilled in the art, the current sink circuitry can be implemented using a resistor with a switch or can be a more complex circuit that functions to control the amplitude of the current.

The surface system 116 can include a processing system 132, one or more memory devices 134, and a transceiver assembly 136 having a transmitter 138 and a receiver 140 for transmitting and receiving signals from the communication nodes 112. The transceiver assembly 136 passes signals to the processing system 132, which is configured to perform various functions, including demodulation and decoding of received signals, and encoding and modulation of data onto carrier signals for transmission to the communication nodes 112. As will be described in further detail below, the transceiver assembly 136 passes received signals to the processing system 132 which is configured to demodulate and decode the signals received on each frequency channel and evaluate the quality of the received information, such as by measuring the SNR on each channel and/or determining the data error rate for each channel in known manners. The results of these analyses can then be used to re-assign and/or adjust the frequency channels that are allocated to the communication nodes 112.

Referring now to FIG. 3, an exemplary process 300 for dynamically adapting assignment of frequency channels to communication nodes 112 is illustrated. In general, a band or channel within the available communication spectrum can be allocated to each communication node 112 during initialization of the communication network. The bandwidth of the channels can be based on the particular environment in which the communication system is deployed and the characteristics of the network, such as, for example, the number of nodes 112, the amount of data each node 112 is anticipated to transmit, the desired data rate, and the separation between bands needed to prevent interference. As an example, in a downhole application, the available spectrum can be on the order of a few Hertz up to 6-10 kHz, depending on the length of the transmission medium 114. The available spectrum can be divided into the number of bands needed for the downhole tools 110, provided that, when all bands are in use together, the bands are separated (e.g., a separation of 100 Hz as an example). The width of the bands is dependent on the particular application in which the communications system is employed. For example, a bandwidth of 100 Hz may be sufficient for downhole tools that make simple measurements (e.g., position of a valve), whereas a bandwidth in the kHz range may be needed for tools that make more complex measurements (e.g., a sonic image).

At block 301, the technique is initiated and, at block 302, the baseline noise level is measured on the transmission medium 114. Generally, the surface system 116 is configured to scan the full range of the frequency spectrum that is available for communications to capture a waveform of a data stream across the spectrum. This waveform is analyzed for noise (e.g., by applying a Fast Fourier Transform analysis) so that noise levels across the spectrum can be identified.

At block 304, the noise level in each frequency channel is determined and low noise level channels are identified. As an example, regions within the available spectrum having noise below a threshold level (as determined by the Fast Fourier Transform analysis) are identified, and then channels within the low-noise regions having sufficient bandwidths for particular nodes 112 can be identified. As another example, if channels already have been assigned to and are in use by the nodes 112, the signal to noise ratio in each channel can be calculated, and the calculated level can be compared to a predetermined threshold or acceptance criteria to determine whether a channel adjustment (e.g., a re-assignment, a bandwidth change, a modulation scheme change, a transmitter power change, etc.) should be implemented. In either case, the identification of low-noise channels can be performed either automatically by the surface system, automatically with manual intervention by an operator, or entirely manually by an operator based on observation of the waveforms and noise measurements.

At block 306, channels with low noise (e.g., noise below the predetermined threshold or that does not meet the acceptance criteria) are assigned to communication nodes 112. The assignment of frequency channels to nodes 112 can be random. Or, the assignment of frequency channels can be based on the requirements of a particular communication node 112, such as the expected band usage of each node 112 (e.g., nodes with large amounts of telemetry or other data to transmit may benefit from the bands with the lowest noise, while nodes with lower traffic may tolerate higher noise levels, the spectrum characteristics associated with the nodes (e.g., side lobes, amplitude, etc.) and parameters that can affect the quality of the communication channel between the surface system 116 and the node 112 (e.g., distance from the surface, cable temperature, etc.).

In embodiments, the bandwidth of the channels that are assigned can be the same for all communication nodes 112. Or, the bandwidth can be selected depending on the requirements of a particular node 112. For example, wider bandwidth channels can be assigned to nodes with higher traffic.

In embodiments in which channels previously have been assigned to nodes 112, channels can be re-assigned from one node 112 to another node 112 provided multiple nodes 112 are not assigned the same channel. Or, an idle low noise channel (i.e., a channel not currently in use by a node 112) can be assigned. Further, channel assignment at block 306 in FIG. 3 also can include adjusting communication parameters of a currently-assigned channel for a node 112 based on SNR or error rates in that channel. For example, the system may respond to observance of a high data error rate in a particular channel by decreasing the bandwidth of that channel, particularly if another low-noise channel is not available for assignment. Other parameters that can be changed to adjust the channel assignment include changing the modulation scheme or increasing the transmitter power of the particular node 112.

Channel assignments or adjustments can be determined automatically by the surface system 116. In other embodiments, the surface system 116 can identify a region of low noise in the frequency spectrum and then an operator of the system can manually select or adjust channels within that region for assignment to particular communication nodes 112.

The surface system 116 then communicates the channel assignments (or adjusted channel assignments) to the communication nodes 112 via a communication sent on a downlink of the transmission medium 114. In embodiments, the downlink is configured so that it is immune to noise that is present in the environment in order to ensure that channel assignments reach the nodes 112. To that end, the downlink can be a low frequency communication path on which the channel assignment information is transmitted. As an example, configuration information on the downlink can be transmitted at the rate of 5 bits/second while data on the uplink is communicated at the rate of 4 kilobits/second. To provide further immunity to noise, the assignment information also can be transmitted using a high amplitude communication signal.

At block 308, once the channel assignments are received by the nodes 112, the communication nodes 112 can transmit data to the surface system 116. For example, the channel assignments can be stored in the nodes 112 and then, at a later time, transmission can begin in response to a poll from the surface system 116 received on the downlink. Or, transmission can occur immediately or as soon as the node 112 has data that it is ready to send to the surface. At block 310, the transceiver assembly 136 in the surface system 116 receives the signals transmitted in each channel and the processing system 132 demodulates and decodes the data. At block 312, the processing system 132 measures the quality of each channel, such as by determining the SNR and/or the data error rate associated with each channel. At block 314, if channel quality meets a predefined acceptance criteria, then the collection of data continues without any adjustment of channel assignments. If the channel quality in any channel does not meet the acceptance criteria, then the process returns to block 302 so that channel adjustments can be implemented. Again, as described above, the surface system 116 scans the entire spectrum to obtain a measure of the baseline noise on the transmission medium 114. The noise level in each frequency channel within the spectrum then can be determined in order to identify the channels with low noise.

Channel adjustments thus can be made on a dynamic basis, thus providing for a noise-robust communication system. For example, for each frame of information that is received in a particular channel, the data is collected (block 310) and the SNR and/or error rate is determined (block 312). Accordingly, on a frame-by-frame basis (and depending on the communication capabilities of the downlink), the system can respond and make channel adjustments as needed to adapt to changes in noise levels on the transmission medium, such as the introduction of a new noise source or degradation of an existing noise source), so that communications can be shifted to a noise free or low noise region of the spectrum. In embodiments, the frame rate in the communication system can be on the order of one frame each second so that channel adjustments can be made relatively quickly and seamlessly, as needed. In other embodiments, the adjustments may be slower than frame-by-frame or may be slower than one frame each second.

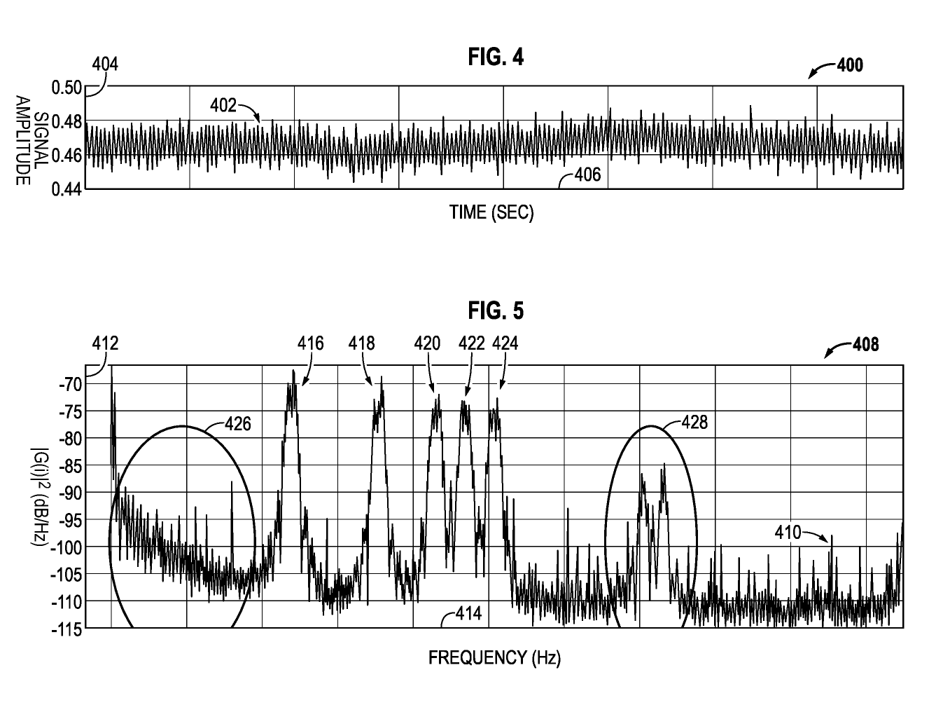

An example of communications in a system in which the technique of FIG. 3 has been applied is shown in FIGS. 4 and 5. Graph 400 in FIG. 4 shows a signal 402 received by the surface system 116 via the communications link 114. The vertical axis 404 of graph 400 represents the signal amplitude and the horizontal axis 406 of graph 400 represents time in seconds. Graph 408 in FIG. 5 depicts the spectrum 410 of signal 402, obtained by a Fast Fourier Transform analysis. The vertical axis 412 represents the strength of the spectral components in dB/Hz. The horizontal axis 414 corresponds to frequency in Hz. In this example, five communication channels 416, 418, 420, 422 and 424 have been assigned to five nodes 112, and the nodes 112 are communicating using their assigned channels. Regions 426 and 428 (encircled on graph 408) of the spectrum 410 are regions in which the noise level is above acceptance criteria. During the channel assignment process, the channels 416-424 purposefully were placed in a low noise region outside of regions 426 and 428.

In the embodiments described thus far, noise levels and channel assignments are determined at the surface, either by the surface equipment 116 alone or with the assistance of a human operator. In other embodiments, the communication nodes 112 themselves can be configured to select or adjust their communication channels, such as, by using a priority scheme so that multiple nodes do not attempt to select the same channel.

It should be understood that the process represented in the flow diagram of FIG. 3 is exemplary only and that other techniques can be implemented to assign or adjust communication channels in response to noise or high error rates. The blocks shown in FIG. 3 also can be ordered in a different manner and may include more or fewer steps. Some blocks can be processed in parallel. As an examples, the process can be configured so that a baseline measurement of the noise on the transmission medium (blocks 302-304) is performed on a periodic basis so that channel assignments can be adjusted (block 306) even without waiting to observe an unacceptable quality in a particular channel when data is collected (blocks 308-314). It also should be understood that the processing of the data to identify the noise levels and assign or adjust channels can be performed by processing systems that are deployed at locations other than the surface system 116, such as a remotely located operator's office. For example, all or portions of the flow diagram shown in FIG. 3 can be performed by a processing system deployed in the communications nodes 112 or by a surface system that is remote from the well. It further should be understood that arrangements and techniques described above for adapting the communications can be applied to any communication network, and are not limited to networks that are deployed in a downhole environment.

In the foregoing description, data and instructions are stored in respective storage devices (such as, but not limited to, storage system 130 in FIG. 2 or the storage system 134 associated with the surface equipment 116 in FIG. 1) which are implemented as one or more non-transitory computer-readable or machine-readable storage media. The storage devices can include different forms of memory including semiconductor memory devices; magnetic disks such as fixed, floppy and removable disks; other magnetic media including tape; optical media such as compact disks (CDs) or digital video disks (DVDs); ROM, RAM, or other types of internal storage devices or external storage devices. The stored instructions can correspond to the adaptive communication schemes described herein and can be executed by a suitable processing device, such as, but not limited to, the processing system 120 in FIG. 2 or the processing system 132 associated with the surface equipment 116 in FIG. 1. The processing device can be implemented as a general purpose processor, a special purpose processor, a microprocessor, a microcontroller, and so forth, and can be one processor or multiple processors that execute instructions simultaneously, serially, or otherwise.

Although the preceding description has been described herein with reference to particular means, materials and embodiments, it is not intended to be limited to the particulars disclosed here; rather, it extends to all functionally equivalent structures, methods and uses, such as are within the scope of the appended claims.

What is claimed is:

1. A method of communicating with communication nodes in a wellbore extending from a surface to a region of interest, comprising:
providing a transmission medium for multiband medium access by a plurality of communication nodes for communication of information associated with downhole equipment;
determining frequency band assignments within a frequency spectrum for multiband communication by the communication nodes on the transmission medium;
transmitting, by the communication nodes, information associated with the downhole equipment to a receiver in accordance with the frequency band assignments;
determining, by the receiver, quality of the received information on each frequency band;
adjusting a frequency band assignment if the quality does not satisfy an acceptance criterion; and
transmitting, by the communication nodes, information associated with the downhole equipment in accordance with the adjusted frequency band assignment.

2. The method as recited in claim 1, wherein determining frequency band assignments comprises:
determining a baseline noise level across the frequency spectrum; and
identifying low noise frequency bands within the frequency spectrum, wherein the low noise frequency bands have noise levels that satisfy an acceptance criterion.

3. The method as recited in claim 1, wherein the frequency band assignments are determined by a surface system at the surface of the wellbore, and the method comprises communicating, by the surface system the frequency band assignments to the communication nodes.

4. The method as recited in claim 3, wherein the receiver is located at the surface, and wherein the information associated with downhole equipment comprises telemetry data.

5. The method as recited in claim 1, wherein determining quality comprises determining a signal to noise ratio.

6. The method as recited in claim 1, wherein determining quality comprises determining an error rate.

7. The method as recited in claim 1, wherein adjusting a frequency band assignment comprises:
determining a baseline noise level across the frequency spectrum;
identifying low noise frequency bands within the frequency spectrum, wherein the low noise frequency bands have noise levels that satisfy an acceptance criterion; and
re-assigning a low noise frequency band to a communication node that previously had transmitted information in an assigned frequency band that did not satisfy the acceptance criterion.

8. The method as recited in claim 1, wherein adjusting a frequency band assignment comprises decreasing a bandwidth of the assigned frequency band.

9. The method as recited in claim 1, wherein adjusting a frequency band assignment comprises changing a modulation scheme used by the communication node to transmit the information.

10. A communication system for communicating with downhole components in a wellbore that extends from a surface to a region of interest, comprising:
a transmission medium deployed in a wellbore, the transmission medium comprising a downlink and a multiband access uplink;
a plurality of downhole components coupled to the transmission medium, wherein the downhole components are assigned respective frequency channels on the multiband access uplink in which to transmit communication signals carrying data measured by the downhole components;
a receiver assembly to receive the communication signals from the downhole components; and
a transmitter assembly to transmit frequency channel assignments to the downhole components on the downlink, wherein the frequency channel assignments are determined dynamically by analyzing quality of the communication signals received in each frequency channel, determining whether the quality meets a quality criterion, and adapting assignment of frequency channels to the downhole components if the quality does not meet the quality criterion.

11. The system as recited in claim 10, wherein the quality of each frequency channel is determined based on a signal to noise ratio.

12. The system as recited in claim 10, wherein the quality is determined based on an error rate in the data received in the frequency channel.

13. The system as recited in claim 10, wherein assignment of frequency channels is adapted by measuring a noise level on the multiband access uplink, identifying frequency channels with a noise level that does not exceed an acceptance criterion, and assigning at least one of the identified frequency channels to a downhole component that was assigned a frequency channel with a quality that did not meet the quality criterion.

14. The system as recited in claim 10, wherein the downhole components comprise pressure gauges to monitor pressure in the region of interest.

15. A method of communicating with communication nodes in a multiband medium access network, comprising:
assigning frequency bands within a frequency spectrum for multiband communication to the communication nodes;
transmitting, by the communication nodes, information to a receiver in accordance with the frequency band assignments;
determining quality of the received information on each frequency band;
adjusting a frequency band assignment if the quality does not satisfy an acceptance criterion; and
communicating the adjusted frequency band assignment to the corresponding communication node.

16. The method as recited in claim 15, further comprising:
determining a baseline noise level across the frequency spectrum;
identifying low noise regions within the frequency spectrum, wherein the low noise regions have noise levels that satisfy an acceptance criterion; and
selecting frequency bands within the low noise regions to assign to the communication nodes.

17. The method as recited in claim 15, wherein determining quality comprises determining a signal to noise ratio.

18. The method as recited in claim 15, wherein determining quality comprising determining an error rate.

19. The method as recited in claim 15, wherein adjusting a frequency band assignment comprises assigning a different frequency band to the communication node.

20. The method as recited in claim 15, wherein adjusting a frequency band assignment comprises decreasing a bandwidth of the assigned frequency band.
